(19) United States
(12) Patent Application Publication
(10) Pub. No.: US 2011/0102681 A1
(43) Pub. Date: May 5, 2011

(54) IMAGE CONVERTING METHOD AND APPARATUS THEREFOR BASED ON MOTION VECTOR-SHARING

(75) Inventors: Jae-hun LEE, Yongin-si (KR); Tae-gyoung AHN, Suwon-si (KR); Jong-hyun PARK, Seoul (KR)

(73) Assignee: Samsung Electronics Co., Ltd., Suwon-si (KR)

(21) Appl. No.: 12/911,546

(22) Filed: Oct. 25, 2010

(30) Foreign Application Priority Data
Nov. 2, 2009 (KR) 10-2009-0104986

(51) Int. Cl. H04N 5/14

(52) U.S. Cl. 348/699; 348/E05.062

(57) ABSTRACT

An image converting method and apparatus therefor for performing resolution conversion or performing frame rate conversion, by sharing at least one motion vector for a current frame, are provided. The image converting method includes estimating at least one motion vector for a current frame of an image sequence; and performing at least one of conversion of resolution of the current frame based on the at least one motion vector and conversion of a frame rate of the image sequence based on the at least one estimated motion vector.

### CROSS-REFERENCE TO RELATED PATENT APPLICATION

This application claims the priority from Korean Patent Application No. 10-2009-0104986, filed Nov. 2, 2009, in the Korean Intellectual Property Office, the disclosure of which is incorporated herein in its entirety by reference.

### BACKGROUND

1. Field

Apparatuses and methods consistent with inventive concept relate to image converting, and more particularly, to converting a resolution and/or a frame rate of an image sequence.

2. Description of the Related Art

With the rapid technological innovation in imaging technology, the imaging apparatuses capable of processing high quality images are increasing in number. The imaging apparatuses may rapidly process an image sequence having a high quality and a high frame rate by using a processor having a fast processing speed, and a high capacity memory.

However, in the case where an input signal that is input to an imaging apparatus is a low quality image sequence, the imaging apparatus may not display a high quality image, even though the imaging apparatus is capable of processing a high quality image. Thus, recently, the methods have been developed to artificially convert a low quality image sequence into a high quality image sequence.

According to one of the related art methods, the image converting apparatuses separately include a chip for conversion of a resolution and a chip for conversion of a frame rate. The image converting apparatuses, according to the related art, separately estimate a motion vector in each of these chips and separately perform the conversion of the resolution and the conversion of the frame rate. This methodology is not efficient because the motion vector needs to be estimated twice.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to one or more exemplary embodiments, there is provided an image converting method and apparatus, and also a computer-readable recording medium having recorded thereon a program for executing the image converting method.

According to an aspect of an exemplary embodiment, there is provided an image converting method including the operations of estimating at least one motion vector for a current frame of an image sequence; and performing at least one of conversion of a resolution of the current frame based on the at least one motion vector and conversion of a frame rate of the image sequence based on the at least one motion vector.

The conversion of the resolution may include the operation of converting the resolution of the current frame by using a multi-frame super-resolution technique.

The conversion of the resolution may include the operation of converting the resolution of the current frame by referring to at least one frame from among a previous frame and a subsequent frame of the current frame, based on the at least one motion vector.

The conversion of the frame rate may include the operation of generating a frame between the current frame, and a previous or subsequent frame of the current frame, based on the at least one motion vector.

The conversion of the frame rate may include the operation of generating the frame between the current frame, and the previous or subsequent frame of the current frame by performing interpolation between frames based on the at least one motion vector.

The operation of estimating the at least one motion vector may further include the operation of refining the at least one motion vector.

According to another aspect of an exemplary embodiment, there is provided an image converting apparatus including a motion estimating unit for estimating at least one motion vector for a current frame of an image sequence; and an image converting unit for performing at least one of conversion of a resolution of the current frame based on the at least one motion vector and conversion of a frame rate of the image sequence based on the at least one motion vector.

According to another aspect of an exemplary embodiment, there is provided a computer-readable recording medium having recorded thereon a program for executing the image converting method.

### BRIEF DESCRIPTION OF THE DRAWINGS

The above and other aspects will become more apparent by describing in detail certain exemplary embodiments with reference to the accompanying drawings, in which:

FIG. 1 is an image converting apparatus according to an exemplary embodiment;

FIG. 2 is an image converting apparatus according to another exemplary embodiment;

FIG. 3 is an image converting apparatus according to another exemplary embodiment;

FIG. 4 is a diagram of resolution conversion by using multiple frames, according to an exemplary embodiment;

FIGS. 5A, 5B, and 5C are diagrams for describing a multi-frame super-resolution technique;

FIG. 6 is a diagram of frame rate conversion, according to another exemplary embodiment;

FIG. 7 is a flowchart of an image converting method, according to an exemplary embodiment; and

FIG. 8 is a flowchart of an image converting method, according to another exemplary embodiment.

### DETAILED DESCRIPTION OF EXEMPLARY EMBODIMENTS

Hereinafter, certain exemplary embodiments are described in greater detail with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

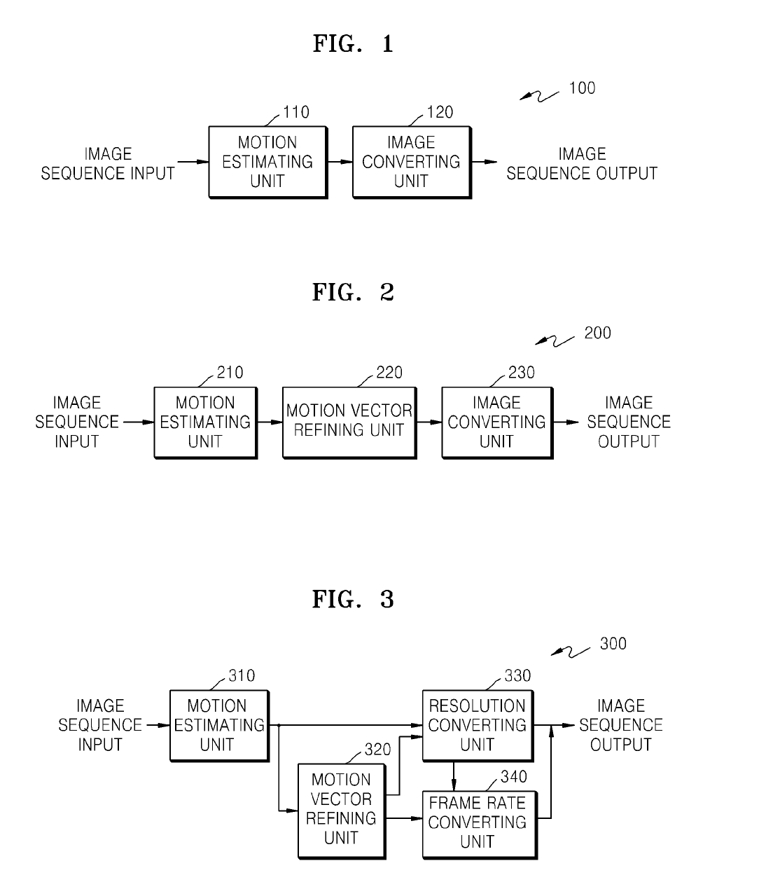

FIG. 1 is an image converting apparatus 100 according to an exemplary embodiment.

Referring to FIG. 1, the image converting apparatus 100 includes a motion estimating unit 110 and an image converting unit 120.

The motion estimating unit 110 estimates at least one motion vector for a current frame. The motion estimating unit 110 may estimate a motion vector for each of a plurality of blocks of the current frame. The motion estimating unit 110 searches for at least one previous or subsequent frame and estimates a motion vector, based on the plurality of blocks of the current frame. Based on each of the plurality of blocks, the motion estimating unit 110 searches for a block having a minimum Sum of Absolute Difference (SAD) in one or more previous frames and/or in one or more subsequent frames, and estimates a motion vector for each of the plurality of blocks according to a result of the searching.

The image converting unit 120 performs at least one of conversion of a resolution of the current frame and conversion of a frame rate of an image sequence, based on the at least one motion vector estimated by the motion estimating unit 110.

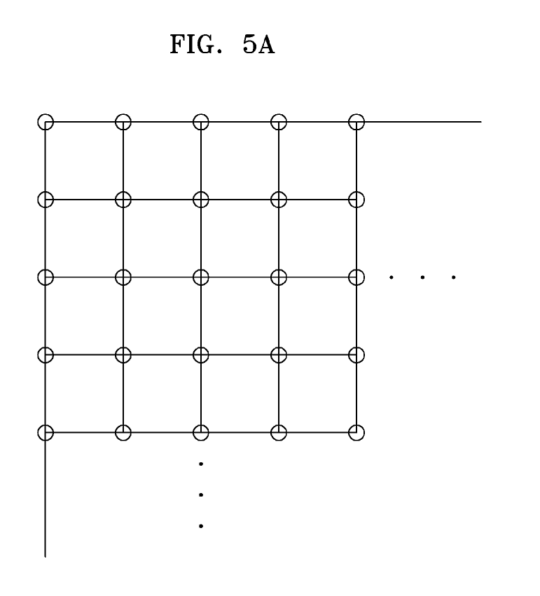

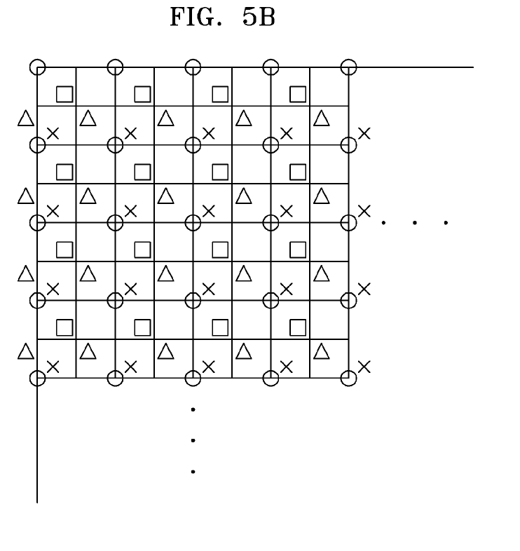

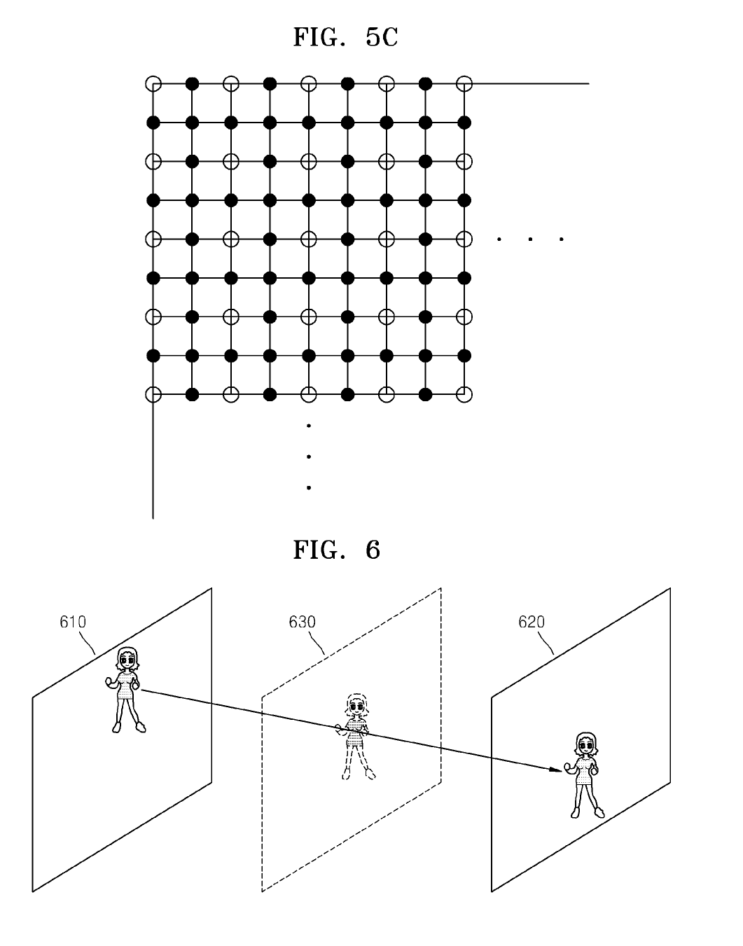

The image converting unit 120 may convert the resolution of the current frame by converting a resolution in a block unit based on the at least one motion vector estimated by the motion estimating unit 110. In the conversion of the resolution, a super-resolution technique may be used. In the image converting apparatus 100 according to this current exemplary embodiment, a single frame super-resolution technique, or a multi-frame super-resolution technique based on the at least one motion vector estimated by the motion estimating unit 110 may be used. A detailed description of the conversion of the resolution is described below with reference to FIGS. 4, 5A, 5B, and 5C.

The image converting unit 120 may convert the frame rate of the image sequence based on the at least one motion vector estimated by the motion estimating unit 110. The image converting unit 120 may convert the frame rate by generating a middle frame between the current frame and a neighboring frame based on the motion vector. The neighboring frame may be a previous frame or a subsequent frame of the current frame. The image converting unit 120 may perform interpolation based on the at least one motion vector estimated by the motion estimating unit 110, and thus may generate the middle frame between the current frame and the previous frame or the subsequent frame of the current frame. A detailed description of the conversion of the frame rate is described below with reference to FIG. 6.

The image converting unit 120 may simultaneously perform the conversion of the resolution and the conversion of the frame rate. The resolution of the current frame may be first converted, and then the frame rate may be converted based on the current frame of which resolution is converted. In addition, the frame rate may be converted, and then the resolution of the current frame and a resolution of the middle frame may be converted.

The image converting unit 120 uses the at least one motion vector estimated by the motion estimating unit 110 in the conversion of the resolution and the conversion of the frame rate. In other words, the image converting unit 120 shares the at least one motion vector estimated by the motion estimating unit 110 and performs the conversion of the resolution and the conversion of the frame rate unlike the image converting apparatuses according to the related art which separately estimate a motion vector for conversion of the resolution and for conversion of the frame rate in each of the chips, and separately perform the conversion of the resolution and the conversion of the frame rate.

In the image converting apparatus 100 according to this exemplary embodiment, the at least one motion vector estimated by the motion estimating unit 110 is shared to be used in the conversion of the resolution and the conversion of the frame rate so that it is possible to substantially reduce or eliminate the inefficiency caused by estimating the motion vector twice. In addition, since the motion vector generated in one module is shared, it is easy to design a chip for performing the conversion of the resolution and the conversion of the frame rate in a single chip.

FIG. 2 is an image converting apparatus 200 according to another exemplary embodiment.

Referring to FIG. 2, the image converting apparatus 200 according to this exemplary embodiment includes a motion estimating unit 210, a motion vector refining unit 220, and an image converting unit 230. As compared to the image converting apparatus 100 of FIG. 1, the image converting apparatus 200 further includes the motion vector refining unit 220.

The motion estimating unit 210 estimates at least one motion vector for a current frame and corresponds to the motion estimating unit 110 of FIG. 1.

The motion vector refining unit 220 refines the at least one motion vector for the current frame, which is estimated by the motion estimating unit 210.

In the case where the motion vector estimation by the motion estimating unit 210 is incomplete, one of the estimated motion vectors may be estimated incorrectly. For example, in the case where only one motion vector for one block from a plurality of blocks of the current frame has a value different from the motion vectors of the other blocks, there is a possibility that this particular motion vector is an incorrect motion vector due to an estimation error, and thus it is necessary to refine the incorrect motion vector to be substantially similar to or the same as the motion vectors of the other blocks. Therefore, the motion vector refining unit 220 may detect the incorrectly estimated motion vector according to a predetermined algorithm and may refine the detected incorrect motion vector.

The image converting unit 230 performs at least one of conversion of a resolution of the current frame and conversion of a frame rate of an image sequence, based on the at least one motion vector refined by the motion vector refining unit 220. Based on the at least one refined motion vector, the conversion of the resolution or the conversion of the frame rate which is previously described in relation to the image converting unit 120 of FIG. 1 is performed.

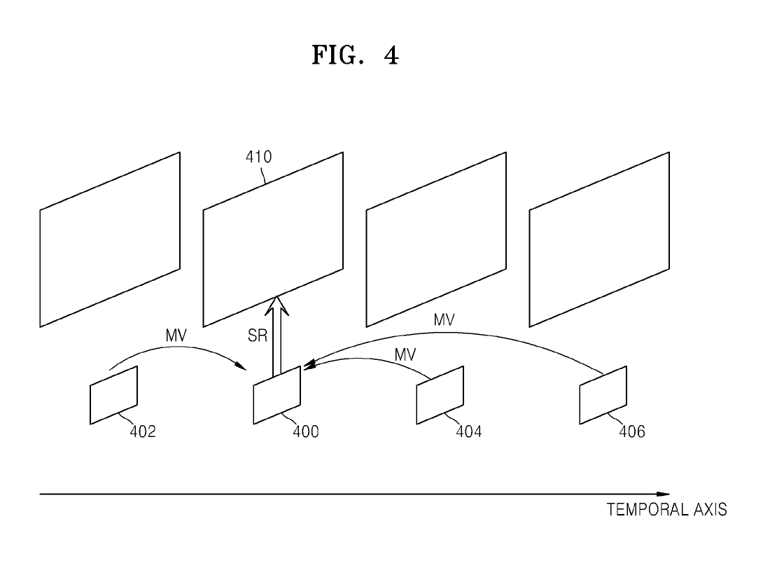

FIG. 3 is an image converting apparatus 300 according to another exemplary embodiment.

Referring to FIG. 3, the image converting apparatus 300 according to the current exemplary embodiment includes a motion estimating unit 310, a motion vector refining unit 320, a resolution converting unit 330, and a frame rate converting unit 340.

The motion estimating unit 310 estimates at least one motion vector for a current frame, and corresponds to the motion estimating unit 110 of FIG. 1.

The motion vector refining unit 320 refines the least one motion vector for the current frame, which is estimated by the motion estimating unit 310. The motion vector refining unit 320 corresponds to the motion vector refining unit 220 of FIG. 2.

The resolution converting unit 330 performs conversion of a resolution of the current frame based on the at least one motion vector estimated by the motion estimating unit 310. The resolution converting unit 330 performs the conversion of the resolution based on the at least one motion vector refined by the motion vector refining unit 320 or based on at least one motion vector that is not refined. The current frame of which resolution is converted by the resolution converting unit 330 may be output as a frame of an image sequence, or may be transmitted to the frame rate converting unit 340 and thus may be used in the conversion of the frame rate.

The frame rate converting unit 340 converts the frame rate of the image sequence based on the at least one motion vector refined by the motion vector refining unit 320. The frame rate converting unit 340 may convert the frame rate by generating a frame between the current frame and a neighboring frame based on the at least one refined motion vector.

The frame rate converting unit 340 may convert the frame rate based on the frame of which resolution is converted by the resolution converting unit 330. In other words, by generating a high resolution frame between the current frame and the neighboring frame, which are converted into high resolution frames, the frame rate may be converted.

FIG. 4 is a diagram of resolution conversion by using multiple frames, according to an exemplary embodiment. FIG. 4 corresponds to the resolution conversion performed by the image converting unit 120 of FIG. 1, the image converting unit 230 of FIG. 2, and/or the resolution converting unit 330.

Referring to FIG. 4, the image converting apparatus 100, 200, or 300 according to the exemplary embodiments may convert a low resolution frame into a high resolution frame by using a super-resolution technique using a single frame or multiple frames. Here, the super-resolution technique using the multiple frames is described.

In order to generate a high resolution frame 410 by converting a current frame 400 by using a plurality of low resolution frames 400, 402, 404, 406 various methods may be used. The various methods are referred to as a multi-frame super-resolution technique.

At least one motion vector is generated by referring to the plurality of low resolution frames 402, 404, 406 which are temporally adjacent to the current frame 400. After that, a ½ sub-pixel or a ¼ sub-pixel of the current frame 400 is interpolated based on the at least one motion vector to generate the high resolution frame 410. This is described in detail below with reference to FIGS. 5A through 5C.

FIGS. 5A through 5C are diagrams for describing the multi-frame super-resolution technique.

FIG. 5A is a diagram of the low resolution current frame 400. In FIG. 5A, positions of pixel values of the low resolution current frame 400 are marked as ‘◯’.

FIG. 5B indicates a result obtained by referring to the neighboring low resolution frames 402, 404, 406 based on the at least one motion vector. Based on the at least one motion vector, the previous low resolution frame 402 of the low resolution current frame 400, and the subsequent low resolution frames 404 and 406 of the low resolution current frame 400 are referred to.

As a result of referring to the previous low resolution frame 402 based on the at least one motion vector, positions of pixel values of the previous low resolution frame 402 may be marked as ‘Δ’ in the low resolution current frame 400. As a result of referring to the subsequent low resolution frames 404 and 406 based on the at least one motion vector, positions of pixel values of the subsequent low resolution frame 404 may be marked as ‘X’ in the low resolution current frame 400, and positions of pixel values of the subsequent low resolution frame 406 may be marked as ‘□’ in the low resolution current frame 400.

After the positions of the pixel values of the neighboring low resolution frames 402, 404, 406 are marked in the low resolution current frame 400, sub-pixels of the low resolution current frame 400 are interpolated based on the pixel values of the marked neighboring low resolution frames 402, 404, 406.

FIG. 5C is a diagram of an interpolated high resolution frame.

Referring to FIG. 5C, pixel values, marked as ‘’, of ½ sub-pixels of the low resolution current frame 400 are generated via interpolation. The ½ sub-pixels may be generated based on the pixel values at the positions marked as ‘Δ’, ‘X’, and ‘□’ in FIG. 5B.

The ½ sub-pixels may be interpolated based on relative distances between the pixel values of the low resolution current frame 400 in FIG. 5A, and the pixel values at the positions marked as ‘Δ’, the pixel values at the positions marked as ‘X’, and the pixel values at the positions marked as ‘□’.

The multi-frame super-resolution technique described above with reference to FIGS. 5A through 5C is one of the techniques for generating a high resolution frame by using a plurality of low resolution frames. In addition to non-uniform interpolation based algorithms illustrated in FIGS. 5A through 5C, various algorithms including maximum a posteriori (MAP) based algorithms, projection onto convex sets (POCS) based algorithms, and iterative back-projection (IBP) based algorithms may be used as the multi-frame super-resolution technique in exemplary embodiments.

However, the high resolution frame of the low resolution current frame 400 may be generated without referring to the neighboring low resolution frames 402, 404, 406. A technique for generating the high resolution frame of the low resolution current frame 400 without referring to the neighboring low resolution frames 402, 404, 406 may be, for example, the single frame super-resolution technique. In this regard, various algorithms including learning based algorithms, examples based algorithms, and edge directed interpolation/regression algorithms may be used as the single frame super-resolution technique.

FIG. 6 is a diagram of the frame rate conversion, according to another exemplary embodiment. FIG. 6 corresponds to the frame rate conversion performed by the image converting unit 120 of FIG. 1, the image converting unit 230 of FIG. 2, and/or the frame rate converting unit 340 of FIG. 3.

Referring to FIG. 6, a middle frame between a current frame 610 and a neighboring frame 620 of the current frame 610 is generated based on a motion vector. The neighboring frame 620 may be a previous frame of the current frame 610, or may be a subsequent frame of the current frame 610.

The middle frame is generated by reflecting a motion of an object or a background included in the current frame 610, based on the motion vector. As illustrated in FIG. 6, a middle frame 630 is generated by reflecting a motion of an object that is included in the current frame 610 and the neighboring frame 620. As a result of the frame rate conversion, a low frame rate image sequence may be converted into a high frame rate image sequence further including the middle frame 630. For example, an image sequence at 60 Hz may be converted into an image sequence at 120 Hz by generating a middle frame between frames.

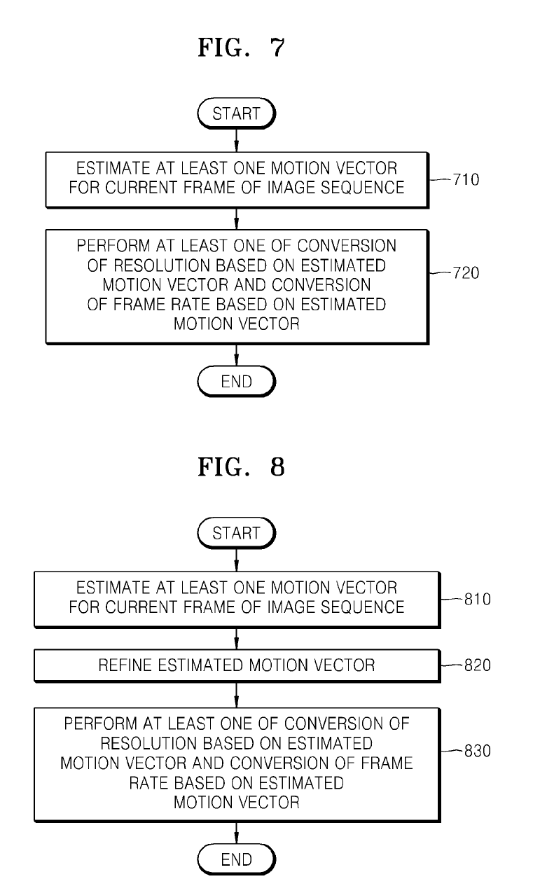

FIG. 7 is a flowchart of an image converting method, according to another exemplary embodiment.

Referring to FIG. 7, in operation 710, the image converting apparatus 100, 200, or 300 estimates at least one motion vector for a current frame. The image converting apparatus 100, 200, or 300 may estimate a motion vector for each of a plurality of blocks of the current frame of the image sequence.

At least one previous or subsequent frame is searched for based on the plurality of blocks of the current frame. A block having a minimum SAD is searched for in at least one previous or subsequent frame. According to a result of the searching, the motion vector for each of the plurality of blocks is estimated.

In operation 720, the image converting apparatus 100, 200, or 300 performs at least one of resolution conversion based on the at least one motion vector estimated in operation 710 and frame rate conversion, based on the at least one motion vector estimated in operation 710.

By sharing the at least one motion vector that is generated as a result of performing motion estimation on the current frame, at least one of the resolution conversion and the frame rate conversion is performed. Since the motion estimation is performed only once, it is possible to remove inefficiency caused by performing motion estimation twice for each of the resolution conversion and the frame rate conversion.

The resolution conversion may be performed according to the super-resolution techniques that are described above with reference to FIGS. 4, 5A, 5B, and 5C, and the frame rate conversion may be performed according to a technique described above with reference to FIG. 6.

FIG. 8 is a flowchart of an image converting method, according to another exemplary embodiment.

Referring to FIG. 8, in operation 810, the image converting apparatus 100, 200, or 300 estimates at least one motion vector for a current frame of an image sequence. Operation 810 corresponds to operation 710 of FIG. 7.

In operation 820, the image converting apparatus 100, 200, or 300 refines the at least one motion vector estimated in operation 810. As described above with reference to the motion vector refining unit 220 of FIG. 2, in the case where the motion vector estimation is incomplete, an incorrectly estimated motion vector may exist. Thus, in operation 820, the image converting apparatus 100, 200, or 300 may detect the incorrectly estimated motion vector according to a predetermined algorithm and may refine the incorrectly detected and estimated motion vector.

In operation 830, the image converting apparatus 100, 200, or 300 performs at least one of resolution conversion based on the estimated at least one motion vector and frame rate conversion based on the estimated at least one motion vector.

Operation 830 is different from operation 720 of FIG. 7 in that the image conversion may be performed in operation 830 by using the motion vector that is refined in operation 820. Based on the motion vector refined in operation 820, the resolution conversion or the frame rate conversion may be performed. Based on the refined motion vector, the resolution conversion and the frame rate conversion may be performed.

While the present invention has been particularly shown and described with reference to exemplary embodiments, it will be understood by those of ordinary skill in the art that various changes in form and details may be made therein without departing from the spirit and scope of the inventive concepts.

For example, the image converting apparatus according to the one or more exemplary embodiments may include a bus coupled to each unit of the image converting apparatuses of FIG. 1, 2, or 3, and at least one processor combined with the bus. Also, a memory for storing a command, a received message, or a generated message may be coupled to the at least one processor that is combined with the bus to execute the command, the received message, or the generated message.

In addition, a data structure used in exemplary embodiments can be written in a computer-readable recording medium through various means. Examples of the computer-readable recording medium include magnetic storage media (e.g., ROMs, floppy disks, hard disks, etc.), optical recording media (e.g., CD-ROMs, or DVDs), etc. The computer-readable recording medium can also be distributed over network-coupled computer systems so that the computer-readable code is stored and executed in a distributed fashion.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image converting method comprising:
estimating at least one motion vector for a current frame of an image sequence; and
performing at least one of conversion of a resolution of the current frame based on the at least one motion vector and conversion of a frame rate of the image sequence based on the at least one estimated motion vector.

2. The image converting method of claim 1, wherein the conversion of the resolution comprises converting the resolution of the current frame by using a multi-frame super-resolution technique.

3. The image converting method of claim 2, wherein the conversion of the resolution comprises converting the resolution of the current frame by referring to at least one of a previous frame and a subsequent frame, based on the at least one estimated motion vector.

4. The image converting method of claim 1, wherein the conversion of the frame rate comprises generating a frame between the current frame and a previous frame and a subsequent frame, based on the at least one estimated motion vector.

5. The image converting method of claim 4, wherein the conversion of the frame rate comprises generating the frame between the current frame and the previous frame or the subsequent frame by performing interpolation between the frames based on the at least one estimated motion vector.

6. The image converting method of claim 1, wherein the estimating of the at least one motion vector comprises refining the at least one motion vector.

7. An image converting apparatus comprising:
a motion estimating unit which estimates at least one motion vector for a current frame of an image sequence; and
an image converting unit which performs at least one of conversion of a resolution of the current frame based on the at least one motion vector and conversion of a frame rate of the image sequence based on the at least one estimated motion vector.

8. The image converting apparatus of claim 7, wherein the image converting unit converts the resolution of the current frame by using a multi-frame super-resolution technique.

9. The image converting apparatus of claim 8, wherein the image converting unit converts the resolution of the current frame by referring to at least one of a previous frame and a subsequent frame, based on the at least one estimated motion vector.

10. The image converting apparatus of claim 7, wherein the image converting unit generates a frame between the current frame and a previous frame or a subsequent frame, based on the at least one estimated motion vector.

11. The image converting apparatus of claim 10, wherein the image converting unit generates the frame between the current frame and the previous frame or the subsequent frame by performing interpolation between the frames based on the at least one estimated motion vector.

12. The image converting apparatus of claim 7, further comprising a motion vector refining unit which refines the at least one estimated motion vector.

13. A computer-readable recording medium having recorded thereon a program which, when executed by a computer, causes the computer to execute the image converting method of claim 1.

14. An image method comprising:
estimating a motion vector for a current frame of a low resolution image sequence; and
performing at least one of a resolution conversion of the current frame into a higher resolution frame and a frame rate conversion of the low resolution image sequence into a higher frame rate image sequence based on the estimated motion vector.

15. The image converting method of claim 14, further comprising:
displaying one of the higher resolution frame and the higher frame rate image sequence on a display.

16. The image converting method of claim 14, wherein the converting the current frame comprises interpolating the current frame with at least one of a previous frame and a subsequent frame based on the estimated motion vector.

17. The image converting method of claim 14, wherein the converting the low resolution image sequence frame rate comprises generating a frame between the current frame and at least one of a previous frame and a subsequent frame based on the estimated motion vector.

18. The image converting method of claim 14, wherein the performing comprises performing the resolution conversion of the current frame and the frame rate conversion of the low resolution image sequence, and the method further comprises
substantially contemporaneously converting the current frame into the higher resolution frame and the low resolution image sequence frame rate into the higher frame rate image sequence based on the estimated motion vector.

19. The image converting method of claim 18. further comprising:
displaying the higher resolution frame and the higher frame rate image sequence on the display.
